(19) United States
(12) Patent Application Publication
(10) Pub. No.: US 2011/0116489 A1
(43) Pub. Date: May 19, 2011

(54) METHOD AND APPARATUS FOR PROVIDING VHT FREQUENCY REUSE FOR WLANS

(75) Inventor: Sudheer A. Grandhi, Pleasanton, CA (US)

(73) Assignee: INTERDIGITAL PATENT HOLDINGS, INC., Wilmington, DE (US)

(21) Appl. No.: 12/946,156

(22) Filed: Nov. 15, 2010

Related U.S. Application Data
(60) Provisional application No. 61/261,085, filed on Nov. 13, 2009.
(60) Provisional application No. 61/261,151, filed on Nov. 13, 2009.

(51) Int. Cl. H04W 24/10; H04W 84/12

(52) U.S. Cl. 370/338

(57) ABSTRACT

An apparatus and method provides very high throughput (VHT) wireless local area network (WLAN) frequency reuse information reports and adjusts operation parameters based on the frequency reuse information reports.

### CROSS REFERENCE TO RELATED APPLICATIONS

This application claims the benefit of U.S. Provisional Applications 61/261,085 and 61/261,151 both filed Nov. 13, 2009, the contents of which are hereby incorporated by reference herein.

### FIELD OF INVENTION

This application is related to wireless communications.

### BACKGROUND

The earliest version of the IEEE 802.11 standard provided a data rate of 1 Mbps. In a subsequent amendment, namely IEEE 802.11b, a physical layer data rate of 11 Mbps was provided. With the introduction of orthogonal frequency division multiplexing (OFDM) in the IEEE 802.11 g and IEEE 802.11a amendments for 2.4 GHz and 5 GHz bands respectively, the data rates supported were increased to 54 Mbps at the physical (PHY) layer. The IEEE 802.11n amendment increased the data rates supported to 100 Mbps on top of the MAC layer.

Wireless Local Area Networks (WLANs) with very high throughput (VHT) of greater than 100 Mbps on top of the MAC layer are being designed. VHT WLANs may also include features such as multi-user multiple-input multiple-output (MU-MIMO) techniques, new coding features, new power save features, and the like. MU-MIMO technology enables simultaneous transmission to multiple WTRUs on the same frequency, and also simultaneous reception from multiple WTRUs on the same frequency. New VHT protection features for VHT packet transmission and legacy packet transmission will also be needed. In a scenario with densely deployed VHT APs, overlapping basic service set (OBSS) management is necessary because of high interference from neighboring BSSes. In a television white space (TVWS) scenario, independently operated networks/devices, (and even dissimilar networks/devices in radio technology), are expected to coexist and operate in the same common TVWS frequency spectrum. These are just a sample of the new features and capabilities needed in VHT WLANs.

For several neighborhood VHT APs/BSSs, operating (i.e. Overlapping BSS or OBSSs) with 80 MHz bandwidth instead of 20 MHz bandwidth, would have very few 80 MHz channels available given a limited spectrum allocation for WLANs. As a result, the large bandwidth channels (for example 40 MHz and 80 MHz) are reused in close proximity by neighboring VHT APs leading to higher interference. This may lead to lower coverage, since only WTRUs in close proximity to the AP enjoy a good communication link. This also leads to an unfairness problem where WTRUs, far removed from the BSS from the AP, suffer a poor communication link or no coverage at all. In addition, there would be a reduction in throughput and user capacity per the AP as well.

This is referred to as the VHT OBSS problem. In addition in a Television White Space (TVWS) scenario, where independently operated networks/devices (and even dissimilar networks/devices in radio technology) are expected to coexist and operate in the same common TVWS frequency spectrum, similar problems as seen in the VHT OBSS problem arise, due to interference between networks.

### SUMMARY

A method for use in wireless communications, by at least a WTRU or an AP, includes providing very high throughput (VHT) wireless local area network (WLAN) frequency reuse information reports; and adjusting operation parameters based on the frequency reuse information reports.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 2 is an example of a frame body format of a typical management action frame.

FIG. 3 is an example of the format of an IE.

FIG. 4 is an example of a VHT Frequency Reuse Request IE format.

FIG. 5 is an example of a VHT Frequency Reuse Report IE format.

FIG. 6 is an example of a VHT Frequency Reuse Request action frame body.

FIG. 7 is an example of a VHT Frequency Reuse Report action frame body.

FIG. 8 is an example of VHT Frequency Reuse Information Reports of neighboring BSSes used by an AP.

FIG. 9 shows a diagram of an example of a VHT channel scan request Information Element format.

FIG. 10 shows a diagram of an example of a Very High Throughput Channel Scan Request Action frame body.

FIG. 11 shows a diagram of an example a Very High Throughput channel scan report Information Element.

FIG. 12 shows a diagram of an example of a Very High Throughput Channel Scan Report Action frame element.

FIG. 13 shows a diagram of an example of Very High Throughput channel scan information reporting.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to an evolved Node-B, a site controller, an access point (AP), or any other type of interfacing device capable of operating in a wireless environment.

Typical receiver functions used to scan channels in the spectrum include Energy Detect (ED), Carrier Sense (CS) and Clear Channel Assessment (CCA) mechanisms. Some typical definitions of ED/CS/CCA receive power mechanisms are as follows: the ED mechanism will indicate “true” if it detects the energy of an incoming signal above a given threshold level and will indicate “false” otherwise; the CS mechanism will indicate “true” if it detects and locks on to a preamble of an incoming signal and will indicate “false” otherwise; the CCA is a mechanism to determine if the channel/medium is “busy” or “idle”; the CCA mechanism may determine the channel to be “busy” if either the CS or ED mechanism indicates “true”; the CCA mechanism may determine the channel to be “idle” if both the CS and ED mechanisms indicate “false” or if the ED mechanism indicates “true” for a specified duration, while the CS mechanism indicates “false.” The ED and CS indications are available only at the Physical layer. The CCA is available at the Physical and medium access control (MAC) Layer.

Infrastructure Discussion

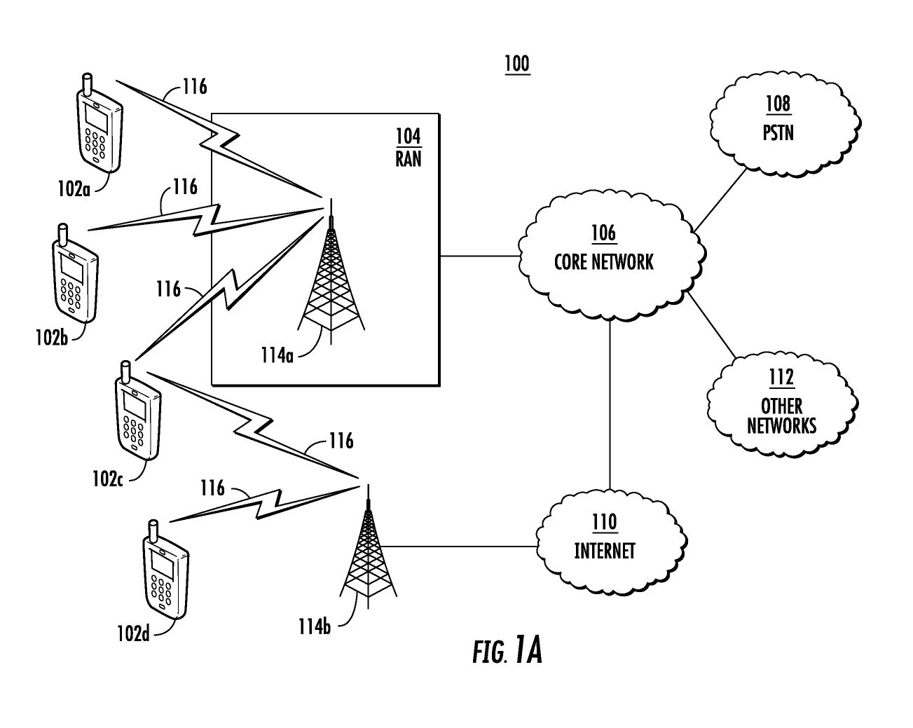

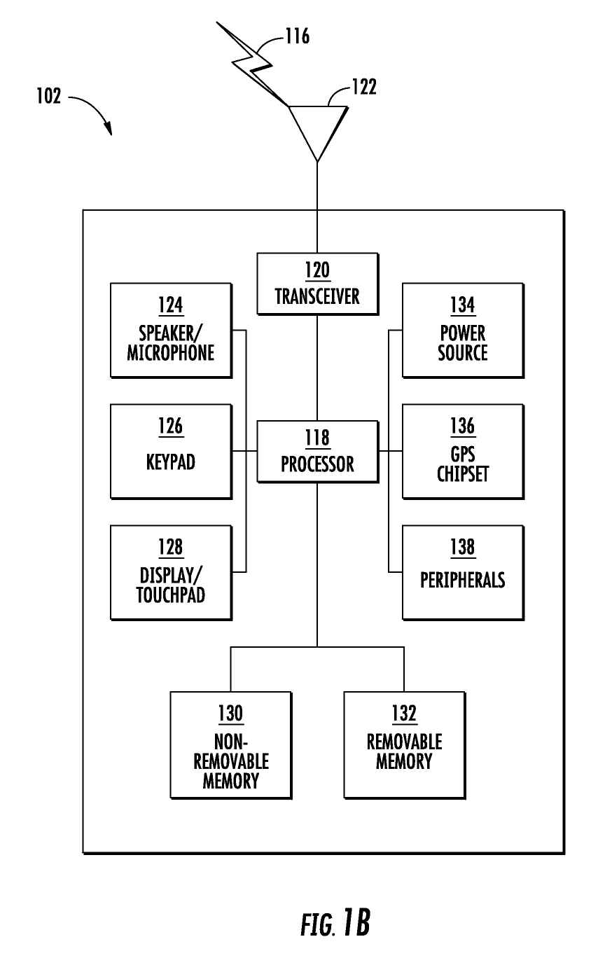

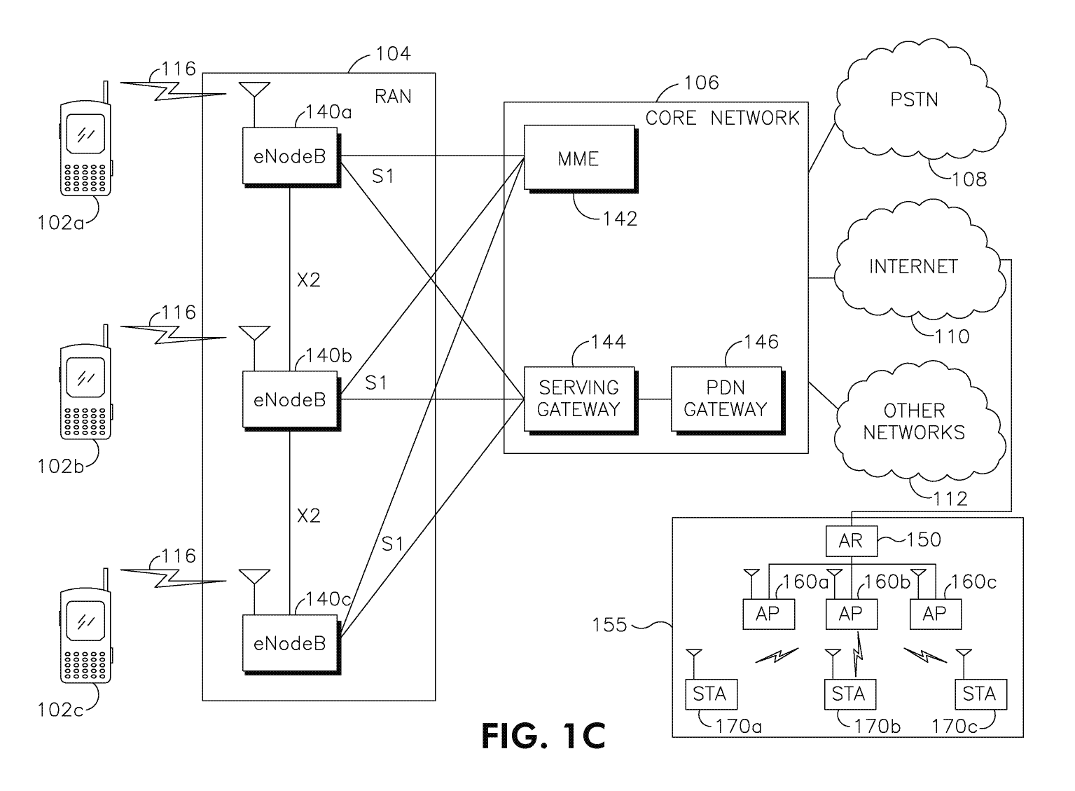

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with WTRUs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway, (e.g., an IP multimedia subsystem (IMS) server), that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Frame Structure

FIG. 2 shows an illustration of the frame body format of an Action Frame, with “k” fields following the Category and Action fields. A Public Action frame is a management frame of Subtype Action. The Category field is set to public. This allows inter-BSS and AP to un-associated WTRU communications. Here “association/un-association” refers to the WTRU “registered/un-registered” status with the AP. For example, in a public action frame: (1) the transmitting WTRU/AP and receiving WTRU/AP may be associated with different BSSes, (2) one or both of the transmitting and receiving WTRUs may not be associated with a BSS.

The fields in the Frame body of a management Action Frame, following the Category and Action fields, may be IEs. The first field in an IE may be an Element ID field that contains an ID specific to the IE. This field may be followed by a Length field that contains the length of the IE. The Length field may be followed by a variable number of fields specific to the IE.

FIG. 3 is an illustration of the format of an IE with “n” fields 206a-206c following the Element ID 202 and Length 204 fields.

VHT Frequency Reuse Information

VHT frequency reuse mechanism may address the VHT OBSS problem in dense deployment of VHT WLANs in urban residential areas. It will also be applicable to enterprise WLANs. The VHT frequency reuse may also be applied in TVWS scenarios in order to reuse spectrum efficiently. It may also apply to an infrastructure BSS where a BSS has an AP and one or more WTRUs. It may also apply to an Independent BSS or a Direct Link Setup scenario.

VHT frequency reuse information of neighboring BSSes may be requested and received by an AP (or an WTRU in a BSS, an Independent BSS or a Direct Link Setup) over the air, the Distribution System (DS) or a back haul wired/wireless network. The VHT frequency reuse information may contain frequency usage, bandwidth usage, channels and channel bandwidth usage patterns, power usage, traffic load information, coexistence policies, and regulatory information. An AP (or a WTRU in a BSS, an Independent BSS or a Direct Link Setup) may adjust its parameters for operation based on VHT frequency reuse information of neighboring BSSs.

In one embodiment, a mechanism is proposed for requesting and reporting information amongst neighboring BSSs on VHT frequency reuse, referred to herein as VHT frequency reuse information.

The VHT frequency reuse information request may contain a simple indication of a request, by setting one or more bits, and may also contain relevant information such as type of reuse information requested.

The VHT frequency reuse information request may be included along with any other inter BSS message transmissions between APs.

The VHT frequency reuse information request may be included along with any other message transmissions by WTRUs in a BSS, an Independent BSS or a Direct Link Setup scenario.

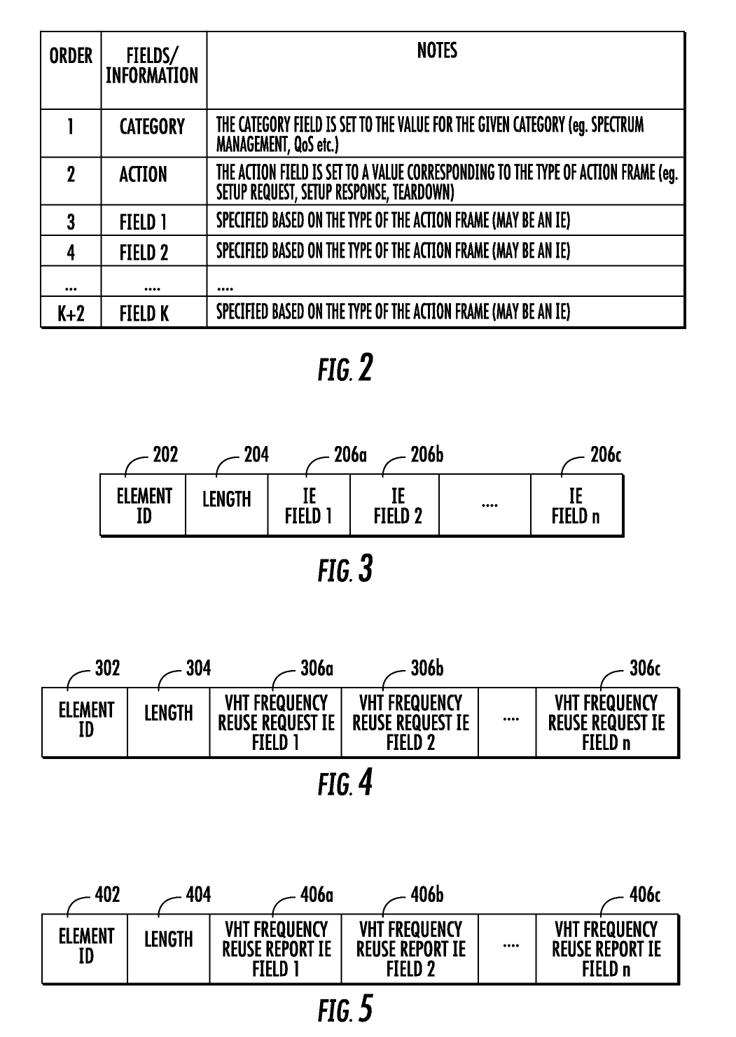

Referring to FIG. 4, the VHT frequency reuse information request may be formatted as a VHT frequency reuse request IE. The Element ID 302 of the VHT frequency reuse request IE, may have a newly defined value, specifically for the VHT frequency reuse request IE. The Length field 304 may contain the length of the VHT frequency reuse request IEs, following the Length field. The fields 306a-306c in the VHT frequency reuse request IE, following the Element ID 302 and Length 304 fields, may not be needed (for example, if all frequency reuse information is expected in the report), but if it is included, it may contain relevant information, such as the type of reuse information requested.

The VHT frequency reuse information report may include information on one or more of the following: 1) frequency information such as used channel numbers/identities, channel bandwidths, channels and channel bandwidths usage patterns (for example, Phase Coexistence Operation where the AP divides time amongst of 20/40 MHz bandwidth transmission phases); 2) transmit powers in the used channels and channel bandwidths; 3) traffic loads on the used channels and channel bandwidths; 4) thresholds, parameters and criteria used in determining proximity in WTRUs (for example, WTRUs close to the AP or having a good quality radio link with the AP); 5) any relevant regulatory information and rules regarding channels and channel bandwidths and transmit/receive powers; 6) parameters for ED/CS/CCA functions for channels and channel bandwidths; and 7) parameters, rules, policies, mechanisms and regulatory information for coexistence (for example, inter-BSS, inter-system or TVWS).

The VHT frequency reuse information report may be included along with any other inter BSS message transmissions between APs.

The VHT frequency reuse information report may be included along with any other message transmissions by WTRUs in a BSS, an Independent BSS or a Direct Link Setup scenario.

The VHT frequency reuse information report may be broadcast or unicast by the APs/WTRUs.

Referring to FIG. 5, the VHT frequency reuse information report may be formatted as a VHT frequency reuse report IE. The Element ID 402 of the VHT frequency reuse report IE may have a newly defined value, specifically for the VHT frequency reuse report IE. The Length field 404 may contain the length of the VHT frequency reuse report IE, following the Length field 404. The fields 406a-406c in the VHT frequency reuse report IE, following the Element ID 402 and Length 404 fields, may contain some or all of the VHT frequency reuse information report.

In FIG. 5, there are “n” fields 406a-406c. The mapping of the VHT frequency reuse information report to the fields of the VHT frequency reuse report IE, following the Length field 404, is flexible. Several different mappings are possible.

The VHT frequency reuse information request/report or VHT frequency reuse request/report IE may be included by an AP in any existing data/control/management frame, as well as in a beacon, an action frame and in a public action frame.

The VHT frequency reuse information request/report or VHT frequency reuse request/report IE may be included by an WTRU in any existing data/control/management frame, like an action frame and a public action frame.

The VHT frequency reuse information request/report or VHT frequency reuse request/report IE may be included by an AP/WTRU in any existing or new packets transmitted over the frequencies used by the BSSs, the Distribution System (DS) or any backhaul wired/wireless network connecting the APs and other networks.

The VHT frequency reuse information request/report or VHT frequency reuse request/report IE may be included by an AP/WTRU in any new or existing packets transmitted over any frequencies/channels, especially on some frequencies/channels that may be reserved for inter-BSS communications or inter-system coexistence communications.

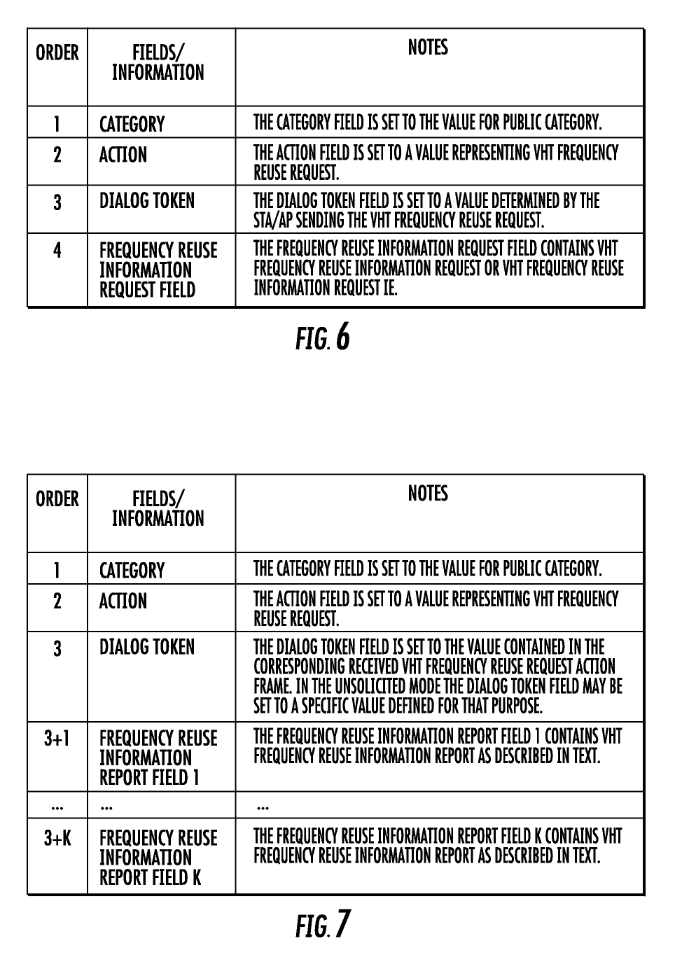

In another embodiment the VHT frequency reuse information request or VHT frequency reuse request IE may be included by an AP/WTRU in a new public action frame referred to herein as a “VHT frequency reuse request” action frame. The frame body of the “VHT frequency reuse request” action frame is shown in FIG. 6.

Referring to FIG. 6, the Category field may be set to a value representing a Public Category. The Action field is set to a value representing a VHT Frequency Reuse Request. The Dialog Token field is set to a value chosen by the requesting WTRU/AP and is used for matching Action Report/Response frames with Action Request frames. The Frequency Reuse Information Request field in FIG. 6 contains a VHT Frequency Reuse Information Request or a VHT Frequency Reuse Information Request IE.

Alternatively, the Frequency Reuse Information Request field in FIG. 6, may be replaced by more than one Frequency Reuse Information Request field and these fields may be mapped to the VHT Frequency Reuse information request. Several different mappings may be possible.

The Category field may be set to a value representing any other existing Action field categories, such as Spectrum Management, holding time (HT), Radio Measurement, Vendor Specific, Wireless Network Management, when the VHT frequency reuse request action frame is used for those categories or purposes.

The Category field may be set to a value representing any new Action field categories such as VHT, when the VHT frequency reuse request action frame is used for those categories or purposes.

In another embodiment, the VHT frequency reuse information report or VHT frequency reuse report IE, may be included by an AP/WTRU in a new public action frame, referred to herein as a “VHT frequency reuse report” action frame. The frame body of the “VHT frequency reuse report” action frame is shown in FIG. 7.

Referring to FIG. 7, the Category field may be set to a value representing a Public Category. The Action field may be set to a value representing a VHT Frequency Reuse Report. The Dialog Token field is set to the value contained in the corresponding received VHT Frequency Reuse Request frame. This field is used for matching Action Report/Response frames with Action Request frames.

If the “VHT frequency reuse report” action frame is sent in an unsolicited mode (i.e. without a matching request action frame), the Dialog Token field may be set to a specific value defined for that purpose. The “k” Frequency Reuse Information Report Field, following the Dialog Token field, will contain the VHT frequency reuse information report, where “k” may take a value of 1 resulting in just one Frequency Reuse Information Report Field.

The mapping of Frequency Reuse Information Report Field(s) to the VHT frequency reuse information report may be flexible and any suitable mapping may be chosen. Several different mappings are possible. For example, the VHT frequency reuse information report may be formatted as a VHT frequency reuse report IE and the VHT frequency reuse report IE may be included as a field, following the Dialog Token field in the “VHT frequency reuse report” action frame.

The “VHT frequency reuse report” action frame may be sent with a broadcast or group destination address, if it is intended for a broadcast or a group of receivers, respectively. The “VHT frequency reuse report” action frame, may be sent with a unicast destination address, if it is intended for a single AP/WTRU.

The Category field, may be set to a value representing any other existing Action field categories such as Spectrum Management, HT, Radio Measurement, Vendor Specific, Wireless Network Management, when the VHT frequency reuse report action frame is used for those categories or purposes.

The Category field, may be set to a value representing any new Action field categories such as VHT, when the VHT frequency reuse report action frame is used for those categories or purposes.

The VHT frequency reuse information request/report, VHT frequency reuse request/report IE, or VHT frequency reuse request/report action frame (public action frame) may be received by WTRUs/APs on the used BSS frequencies and by scanning channels on the frequency spectrum.

The AP may request a WTRU to monitor channels in the spectrum for VHT frequency reuse information reports.

A WTRU may forward a VHT frequency reuse information report, received by the AP, regarding its BSS, in a solicited or unsolicited manner.

The VHT frequency reuse information, may be received by WTRUs/APs on the Distribution System (DS) or any backhaul wired/wireless network connecting the APs and other networks.

FIG. 8 shows another embodiment. An AP 500 (or an WTRU in a BSS, an Independent BSS or a Direct Link Setup), may use VHT frequency reuse information reports 512, 522 of the neighborhood BSSs 510, 520 to adjust its operation parameters 504 related to one or more of the following: 1) used channel numbers/identities, channel bandwidths, channels and channel bandwidths usage patterns (for example, 11n Phase Coexistence Operation where the AP divides time amongst of 20/40 MHz bandwidth transmission phases); 2) transmit powers in the used channels and channel bandwidths; 3) traffic loads on the used channels and channel bandwidths; 4) thresholds, parameters and criteria used in determining proximity in WTRUs (for example, WTRUs close the AP or having a good quality radio link with the AP); 5) any relevant regulatory information and rules regarding channels and channel bandwidths and transmit/receive powers; 6) parameters for ED/CS/CCA functions for channels and channel bandwidths; 7) selection of channels and channel bandwidths for communication with WTRUs; 8) application of a directed beam when communicating with WTRUs; 9) application of antenna selection when communicating with WTRUs; 10) application of transmit beam forming when communicating with WTRUs; 11) application of receive beam forming when communicating with WTRUs; 12) application of transmit power adjustments when communicating with WTRUs; 13) recommendation for other WTRUs/APs on parameters for ED/CS/CCA functions for channels and channel bandwidths; and 14) parameters, rules, policies, mechanisms and regulatory information for coexistence (for example inter-BSS, inter-system or TVWS).

In another embodiment, an AP (or a WTRU in a BSS, an Independent BSS or a Direct Link Setup) may use VHT channel scan information reports received from WTRUs/APs, in addition to VHT frequency reuse information reports of the neighborhood BSSs, to adjust its operation parameters related to one or more of those listed above.

Other embodiments may be possible. A few variants may be generated by merely changing the order of newly added fields in the frame/message formats. Other variants are possible, by using only some of the new fields proposed.

The teachings herein may be implemented as a network having an access point with multiple WTRUs, at the data link layer, medium access control layer, or network layer, as an application specific integrated circuit (ASIC), digital signal processor (DSP) or software. The teachings disclose an 802.11 based WLAN systems or OFDM/MIMO using radio resource management (RRM) and a radio resource controller (RRC), however they may be applied to other types of wireless systems both existing and hereinafter inverted.

VHT Scan Request Information

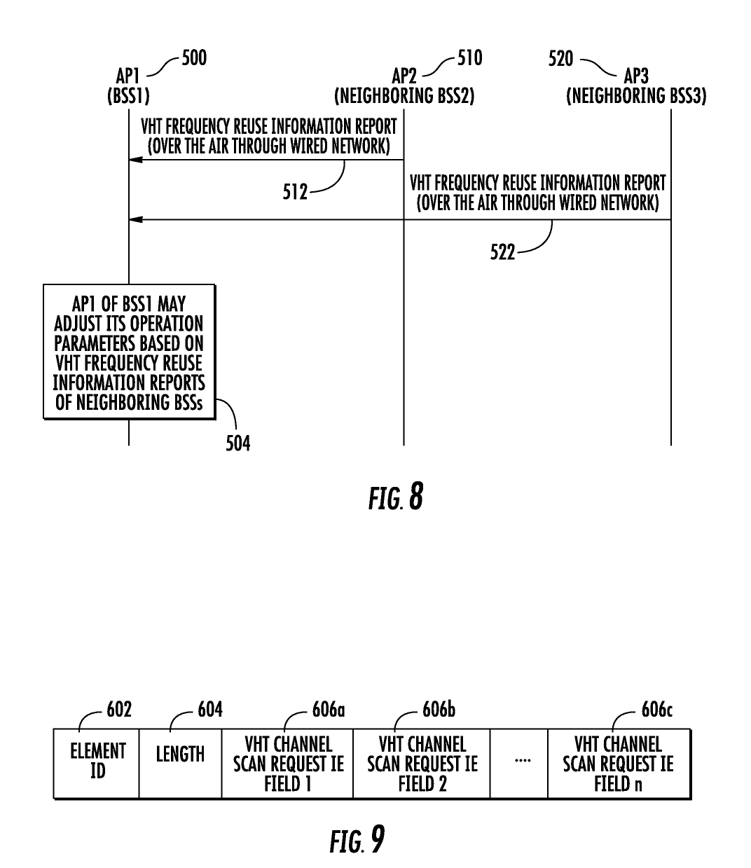

FIG. 9 shows a diagram of an example of a VHT Channel Scan Request IE. A management frame, such an Action subtype management frame or an Action No Acknowledgment subtype management frame, may be used for extended management actions, such as Spectrum Management or quality of service. For simplicity, management frames may be referred to as “Action frames” or “management Action frames” herein. The Frame Body of a management Action frame may begin with an Action Category field, followed by an Action field, which may identify a type of Action frame, such as Setup Request, Setup Response, or Teardown. The Action field may be followed by other fields based on the Action Frame type where one or more of these fields may be an Information Element (IE). As shown in FIG. 9, the frame body for a VHT Channel Scan request format may include n 606a-606c fields following the Category and Action fields.

FIG. 9 shows a diagram of an example of a VHT channel scan request IE. The Element ID 602 of the VHT channel scan request IE may include a value for the VHT channel scan request IE. The Length field 604 may include the length of the VHT channel scan request IE following the Length field. The fields 606a-606c in the VHT channel scan request IE, following the Element ID and Length fields, may contain some or all of the VHT channel scan request information. For example, FIG. 9 shows “n” VHT channel scan request information fields. The mapping of VHT channel scan request information to the fields of the VHT channel scan request IE following the Length field may be flexible. One skilled in the art may recognize that various mappings may be implemented.

For example, a management frame of Subtype Action with the Category field set to Public, such as an 802.11 Public Action frame may be used for inter-BSS and AP to unassociated-STA communications. For example, in a public action frame the transmitting STA or AP and the receiving STA or AP may be associated with different BSSs. In addition, one or both of the transmitting and receiving WTRUs may not be associated to a BSS.

A WTRU, such as an AP or a STA in a BSS, an Independent BSS, or in a Direct Link configuration, may send a VHT channel scan request to a specific WTRU or may send a VHT channel scan indication in a broadcast. For simplicity, a targeted request or broadcast indication may be referenced to hereinafter as a VHT channel scan request. In response to a VHT channel scan request, VHT channel scan report information may be generated by scanning channels in the spectrum.

A VHT channel scan request may include information associated with channels and channel bandwidths to scan, interference power thresholds, measurement time parameters, parameters for ED/CS/CCA functions for channels and channel bandwidths, regulatory information and rules regarding channels, channel bandwidths, and transmit/receive power, or measurement modes to use, such as active scan or passive scan.

The VHT channel scan request may be included in a data or control frame, such as a new frame, or an existing frame. The VHT channel scan request may also be included in an action, public action, or management frame, such as a beacon, association, re-association, or probe response.

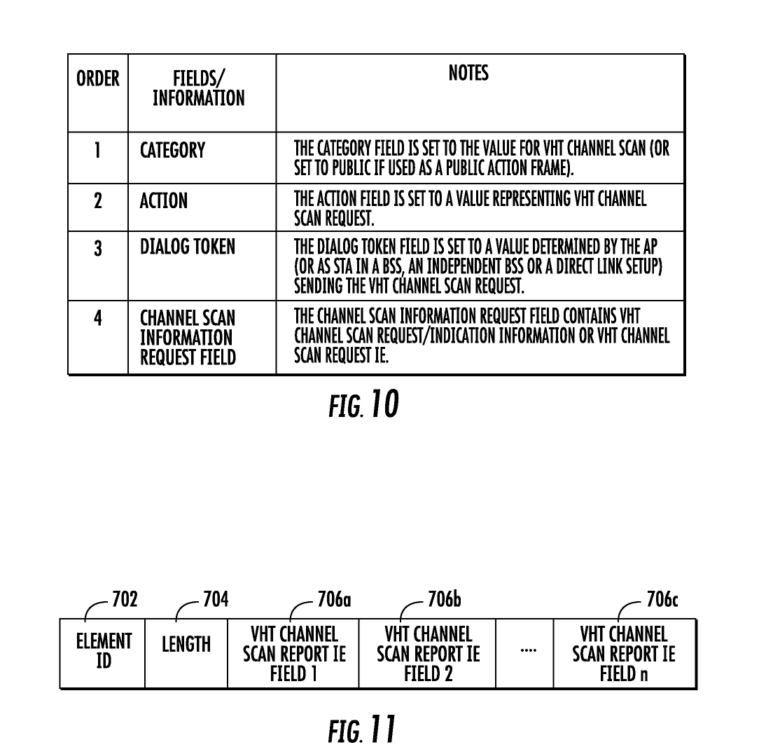

FIG. 10 shows a diagram of an example of a VHT Channel Scan Request Action frame. The Category field may be set to a value representing VHT Channel scan. The Action field may be set to a value representing VHT or VHT channel scan request. The Dialog Token field may be set to a value chosen by the requesting WTRU and may be used for matching Action Report or Response frames with Action Request frames. The Channel Scan Information Request field may include VHT Channel Scan Information Request information, or a VHT Channel Scan Request IE. Alternatively, the Channel Scan Information Request field may be replaced by more than one Channel Scan Information Request field that may be mapped to the VHT Channel Scan request information.

The Category field may be set to a value representing a Public category, for example, where the VHT Channel Scan Request action frame is used as a Public Action frame. The VHT Channel Scan Request action frame as a public action frame may be used, for example, when this frame is to be received by a WTRU that is associated with a different BSS or not associated to a BSS.

The Category field may be set to a value representing another action field category, for example, an existing 802.11 Action field category, such as Spectrum Management, HT, Radio Measurement, Vendor Specific, Wireless Network Management. For example, when the VHT Channel Scan Request action frame is used for those categories or purposes.

The VHT channel scan report information may include information related to interference power on VHT channels and channel bandwidths, signal to interference ratio on channels and channel bandwidths, interference power exceeding specified thresholds, indications from ED/CS/CCA functions for channels and channel bandwidths, recognized BSS identities on channels and channel bandwidths, or regulatory information or rules regarding channels or channel bandwidths and transmit/receive powers.

FIG. 11 shows a diagram of an example of a VHT Channel scan report IE. The VHT channel scan report information may be formatted as a VHT channel scan report IE. The Element ID 702 of the VHT channel scan report IE may include a value for the VHT channel scan report IE. The Length field 704 may include the length of the VHT channel scan report IE following the Length field 704. The fields 706a-706c in the VHT channel scan report IE, following the Element ID 702 and Length 704 fields, may contain some or all of the VHT channel scan report information. For example, as shown in FIG. 11, the IE may include “n” information fields. Various mappings may be implemented. The mapping of VHT channel scan report information to the fields of the VHT channel scan report IE following the Length field may be flexible.

A WTRU may send the VHT channel scan report information or VHT channel scan report IE in a data or control frame, such as a new frame or an existing frame, in a solicited manner, such as in response to a specific request to the WTRU, or unsolicited manner, for example based on scan parameters included or indicated in a broadcast message.

A WTRU may also send the VHT channel scan report information or VHT channel scan report IE in a management, action, or public action frame, such as a new or existing frame, in a solicited manner, such as in response to a specific request to the WTRU, or unsolicited manner, for example based on scan parameters included or indicated in a broadcast message.

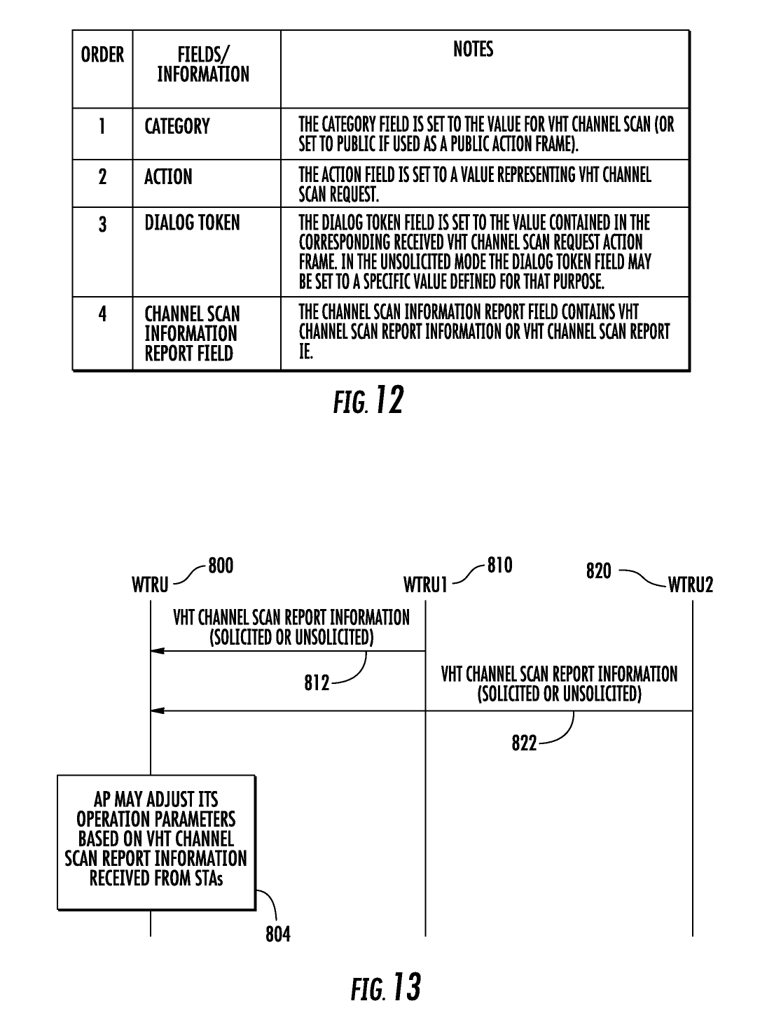

FIG. 12 shows a diagram of an example of the frame body of a VHT Channel Scan Report Action Frame. The VHT Channel Scan Report Action Frame may include VHT channel scan report information. The Category field may include a value representing VHT or VHT Channel scan. The Action field may include a value representing VHT channel scan report. The Dialog Token field may include a value contained in the corresponding received VHT Channel Scan Request Action frame. In the unsolicited mode, the Dialog Token field may include a specific value defined for that purpose. The Channel Scan Information Report field may include VHT Channel Scan report information or a VHT Channel Scan Report IE. Alternatively, the Channel Scan Information Report field may be replaced by more than one Channel Scan Information Report field that may be mapped to the VHT Channel Scan report information. One skilled in the art may recognize that various mappings may be implemented without exceeding the scope of the embodiments recited herein.

The Category field may include a value representing a Public category, for example, where the VHT Channel Scan Report action frame is used as a Public Action frame. The VHT Channel Scan Report action frame may be used as a public action frame, for example, when the frame is to be received by an AP that is associated with different BSS.

The Category field may include a value representing another Action field category, such as an existing 802.11 Action field category, for example, Spectrum Management, HT, Radio Measurement, Vendor Specific, or Wireless Network Management, such as when the VHT Channel Scan Report action frame is used for those categories or purposes.

FIG. 13 shows a diagram of an example of VHT channel scan information report use. A WTRU 800 may use VHT channel scan information reports 812, 822 received from other WTRUs 810, 820 to adjust its operation parameters related to used channel numbers or identities, channel bandwidths, channels and channel bandwidths usage patterns, such as Phase Coexistence Operation where the AP divides time amongst of 20/40 MHz bandwidth transmission phases. The received reports may be used to adjust 804 transmit powers in the used channels and channel bandwidths, or traffic loads on the used channels and channel bandwidths. The reports may be used to adjust thresholds, parameters, and criteria used in determining close WTRUs, such as WTRUs having a good quality radio link with the AP. The reports may be used for adjusting regulatory information and rules regarding channels and channel bandwidths and transmit/receive powers. The received reports may be used to adjust parameters for ED/CS/CCA functions for channels or channel bandwidths.

The received reports may also be used to adjust selection of channels or channel bandwidths, application of a directed beam, application of antenna selection, application of transmit beamforming, application of receive beamforming, or application of transmit power adjustments, when communicating with WTRUs. The received reports may be used to adjust recommendation for other WTRUs on parameters for ED/CS/CCA functions for channels or channel bandwidths. The received reports may be used to adjust for parameters, rules, policies, mechanisms, or regulatory information for coexistence, for example inter-BSS, inter-system or TVWS.

A WTRU may use VHT frequency reuse information reports of the neighborhood BSSs in addition to VHT channel scan information reports received from WTRUs, to adjust its operation parameters.

It should be apparent that the embodiments described herein are illustrative, and that other variations may be performed. For example, the order of fields may be altered in the frame or message formats; or a subset of the fields described herein may be used.

Channel scanning may be performed in a network having a base station with multiple WTRUs, at the data link layer, medium access control layer, or network layer, as an application specific integrated circuit (ASIC), digital signal processor (DSP) or software.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in wireless communications, the method comprising:
providing very high throughput (VHT) wireless local area network (WLAN) frequency reuse information reports; and
adjusting operation parameters based on the frequency reuse information reports.

2. The method of claim 1, wherein the VHT frequency reuse is provided to a basic service set (BSS), where the BSS includes an access point (AP) and a plurality of wireless transmit/receive units (WTRUs).

3. The method of claim 1, wherein the VHT frequency reuse information is based on basic service sets (BSSs).

4. The method of claim 1, wherein the operation parameter comprises channel identities.

5. The method of claim 1, wherein the operation parameter comprises channel bandwidths.

6. The method of claim 1, wherein the operation parameter comprises channel usage patterns.

7. The method of claim 1, wherein the operation parameter comprises channel bandwidth usage patterns.

8. The method of claim 1, wherein the frequency reuse information report comprises signal transmission powers.

9. The method of claim 1, wherein the frequency reuse information report comprises traffic loads.

10. The method of claim 1, wherein the frequency reuse information report is broadcast by a WTRU.

11. The method of claim 1, wherein the frequency reuse information report is broadcast by an access point.

12. The method of claim 1, wherein the frequency reuse information report is comprised in a beacon.

13. The method of claim 1, wherein the frequency reuse information report is comprised in a management action frame or public action frame.

14. A wireless transmit/receive unit (WTRU) comprising:
receiving very high throughput (VHT) wireless local area network (WLAN) frequency reuse information reports; and
adjusting operation parameters based on the frequency reuse information reports.

15. The WTRU of claim 14, wherein the VHT frequency reuse information is based on basic service sets (BSSs).

16. The method of claim 14, wherein the operation parameter comprises channel identities.

17. The method of claim 14, wherein the operation parameter comprises channel bandwidths.

18. The method of claim 14, wherein the operation parameter comprises channel usage patterns.

19. The method of claim 14, wherein the operation parameter comprises channel bandwidth usage patterns.

20. The method of claim 14, wherein the frequency reuse information report comprises signal transmission powers.

21. A method for use in wireless communication comprising:
performing very high throughput (VHT) wireless local area network (WLAN) channel scanning.

22. A method for use in wireless communication, the method comprising:
performing very high throughput (VHT) wireless local area network (WLAN) channel scanning using a VHT channel scan request.
